(19) United States
(12) Patent Application Publication
(10) Pub. No.: US 2015/0188903 A1
(43) Pub. Date: Jul. 2, 2015

(54) METHOD AND SYSTEM FOR GENERATING A PASSWORD FOR AN IMAGE FORMING APPARATUS

(71) Applicant: Konica Minolta Laboratory U.S.A., Inc., San Mateo, CA (US)

(72) Inventor: Toshiyuki MITSUBORI, San Mateo, CA (US)

(73) Assignee: Konica Minolta Laboratory U.S.A., Inc., San Mateo, CA (US)

(21) Appl. No.: 14/145,038

(22) Filed: Dec. 31, 2013

(51) Int. Cl. H04L 29/06; G06F 3/12

(52) U.S. Cl. CPC H04L 63/083; G06F 3/1222; G06F 3/1238

(57) ABSTRACT

A method and system for generating a password for an image forming apparatus is disclosed, the method includes the steps of: providing a password setting mode on the image forming apparatus configured to automatically generate a password for the image forming apparatus after the image forming apparatus is ready to operate for image formation; determining if the password setting mode on the image forming apparatus is enabled or disabled; confirming a status of the image forming apparatus being ready to operate for image formation; and if the password setting mode is enabled, automatically generating the password for the image forming apparatus after confirming the status.

### FIELD

This invention relates to a method and system for automatically generating a password for an image forming apparatus, and more particularly, for automatically generating a random password for an image forming apparatus.

### BACKGROUND

Customer support can be an important feature for consumers in the consideration of purchasing and/or leasing an image forming apparatus. Once an image forming apparatus has been set up and activated, the service technician may forget to set a network password for the apparatus, or alternatively, the password can be set to a password, which can be easily remembered, for example, “password”. If for example, the service technician forgets to set the password for the image forming apparatus, the image forming apparatus will use a default password.

Accordingly, without setting a secure password, the image forming apparatus can be subjected to attacks from both inside and/or outside of the network, which can present security risks for information stored or contained on the image forming apparatus.

### SUMMARY

In consideration of the above issues, it would be desirable to have an image forming apparatus, which automatically generates a password, for example, a randomly generated password, upon initialization and/or set up of the image forming apparatus as disclosed herein.

In accordance with an exemplary embodiment, a method for generating a password for an image forming apparatus is disclosed, the method comprising: providing a password setting mode on the image forming apparatus configured to automatically generate a password for the image forming apparatus after the image forming apparatus is ready to operate for image formation; determining if the password setting mode on the image forming apparatus is enabled or disabled; confirming a status of the image forming apparatus being ready to operate for image formation; and if the password setting mode is enabled, automatically generating the password for the image forming apparatus after confirming the status.

In accordance with an exemplary embodiment, a computer program product comprising a non-transitory computer readable medium having a computer readable code embodied therein for generating a password for an image forming apparatus is disclosed, the computer readable program code configured to execute a process, which includes the steps of: providing a password setting mode on the image forming apparatus configured to automatically generate a password for the image forming apparatus after the image forming apparatus is ready to operate for image formation; determining if the password setting mode on the image forming apparatus is enabled or disabled; confirming a status of the image forming apparatus being ready to operate for image formation; and if the password setting mode is enabled, automatically generating the password for the image forming apparatus after confirming the status.

In accordance with an exemplary embodiment, an image forming system is disclosed, the image forming system comprising: at least one client device; and an image forming apparatus, the image forming apparatus configured to perform the following: providing a password setting mode on the image forming apparatus configured to automatically generate a password for the image forming apparatus after the image forming apparatus is ready to operate for image formation; determining if the password setting mode on the image forming apparatus is enabled or disabled; confirming a status of the image forming apparatus being ready to operate for image formation; and if the password setting mode is enabled, automatically generating the password for the image forming apparatus after confirming the status.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an illustration of an image forming system for generating a password for an image forming apparatus in accordance with an exemplary embodiment;

FIG. 2 is an illustration of an image forming system, wherein a service center representative can access an image forming apparatus, and which can be subjected to attacks from outsiders, which are not authorized to access the image forming apparatus in accordance with an exemplary embodiment;

FIG. 3 is an illustration of the image forming system, wherein the image forming apparatus can be subjected to an attack from outside a network by a computer hacker in accordance with an exemplary embodiment;

FIG. 4 is an illustration of an image forming system, wherein the image forming apparatus can be subjected to an attack from inside a network by a computer hacker in accordance with an exemplary embodiment; and

FIG. 5 is a flow chart illustrating a process of generating a password for an image forming apparatus in accordance with an exemplary embodiment.

### DESCRIPTION OF THE PREFERRED EMBODIMENTS

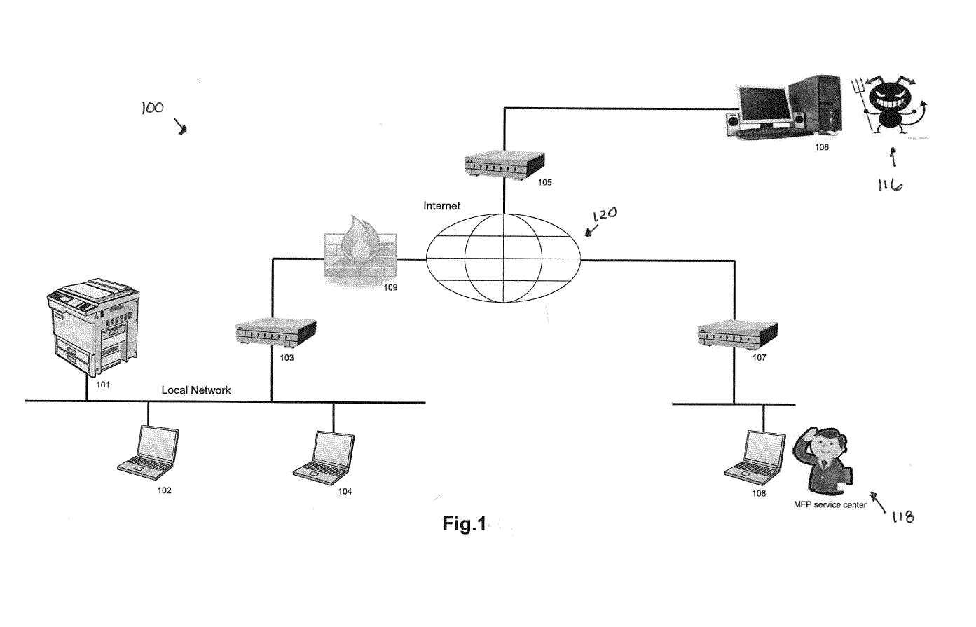

FIG. 1 is an illustration of an image forming system 100 for generating a password for an image forming apparatus in accordance with an exemplary embodiment. As shown in FIG. 1, the system 100 includes an image forming apparatus 101, one or more clients or client devices 102, 104, 106, 108 and one or more routers, networking devices and/or hubs 103, 105, 107. In accordance with an exemplary embodiment, a firewall 109 can exist between the image forming apparatus 101 and the one or more client or client devices 106, 108. For example, in accordance with an exemplary embodiment, one or more of the client devices 106 can be operated by an individual or user, which does not have permission or authorization to use or access the image forming apparatus 101.

In addition, one or more of the client devices 108 can be hosted or located in a service center, which includes a service center representative 118, which provides maintenance and other related services to the image forming apparatus 101. In accordance with an exemplary embodiment, the administrator may not have direct access to the image forming apparatus 101, such that access to the image forming apparatus 101 can be through one or more devices having a firewall 109.

In accordance with an exemplary embodiment, the image forming apparatus 101, the one or more clients 102, 104, 106, 108, the one or more routers, networking devices and/or hubs 103, 105, 107, and the firewall 109, can be connected via an Internet or network connection 120, such as a LAN (Local Area Network) or WAN (Wide Area Network).

In accordance with an exemplary embodiment, each of the one or more client devices 102, 104, 106, 108 includes a processor or central processing unit (CPU), and one or more memories for storing software programs and data (such as files to be printed). The processor or CPU carries out the instructions of a computer program, which operates and/or controls at least a portion of the functionality of the client devices 102, 104, 106, 108. Each of the client devices 102, 104, 106, 108, can also include an operating system (OS), which manages the computer hardware and provides common services for efficient execution of various software programs. For example, the software programs can include application software and printer driver software. The printer driver software controls the image forming apparatus 101 connected with the client devices 102, 104, 106, 108 in which the printer driver software is installed. In certain embodiments, the printer driver software produces a print job and/or document based on an image and/or document data. In addition, the printer driver software can control transmission of the print job from the client device 102, 104, 106, 108 to the image forming apparatus 101.

Each of the one or more client devices 102, 104, 106, 108 can also include a display in the form of a graphical user interface. In accordance with an exemplary embodiment, the printer driver software generates a printer driver user interface or graphical user interface in which the user of the one or more client devices 102, 104, 106, 108 can provide instructions to the image forming apparatus 101. In addition, each of the client devices 102, 104, 106, 108 can be configured to receive e-mails, for example, from the image forming apparatus 101 via the network connection 120 and/or wireless technology including but not limited to radio frequency (RF) and/or infrared (IR) transmission.

In accordance with an exemplary embodiment, for example, an administrator can access an e-mail generated by the image forming apparatus 101 on client device 102, 104, 108, which can include a randomly generated password for the image forming apparatus 101 as disclosed herein. Examples of client devices 102, 104, 108 can include and are not limited to personal computers, routers, image forming apparatuses, and/or personal digital assistants (PDAs).

In accordance with an exemplary embodiment, the image forming apparatus 101 is preferably in the form of an industrial image forming apparatus or multi-functional printer (MFP) connected to the one or more client devices 102, 104, 106, 108. The one or more client devices 102, 104, 106, 108 can be configured to submit print jobs to the image forming apparatus (printer or printing device) 101 by transmitting data representing the documents to be printed and information describing the print job. The image forming apparatus (for example, printer/printing device) 101 can include a printer controller (or firmware), a memory section preferably in the form of a hard disk drive (HDD), an image processing section (or data dispatcher), a print engine, and an input/output (I/O) section.

The controller of the image forming apparatus 101 can include a central processing unit (CPU), a random access memory (RAM), and a read only memory (ROM). The central processing unit can be configured to execute a sequence of stored instructions (e.g., a computer program). It can be appreciated that the controller also includes an operating system (OS), which acts as an intermediary between the software programs and hardware components within the image forming apparatus 101. The operating system (OS) manages the computer hardware and provides common services for efficient execution of various application software. In accordance with an exemplary embodiment, the controller processes the data and job information received from the one or more client devices 102, 104, 106, 108 generates a print image.

The image processing section carries out image processing under the control of the controller, and sends the processed print image data to the print engine. The image processing section is preferably capable of processing multiple print jobs or sub-jobs in parallel and independently. For instance, the image processing section can include a CPU that contains multiple cores therein to realize the multiple RIP modules explained in detail later. The CPU used constituting a part of the controller can be commonly used for the image processing section. The print engine forms an image on a recording sheet based on the image data sent from the image processing section. The I/O section performs data transfer with the one or more client devices 102, 104, 106, 108. The controller is programmed to process data and control various other components of the image forming apparatus or printer to carry out the various methods described herein. The hard disk drive (HDD) or storage device stores digital data and/or software programs for recall by the controller. In accordance with an exemplary embodiment, the digital data includes resources, which can include graphics/images, logos, form overlays, fonts, etc.

Examples of an image forming apparatus 101 consistent with exemplary embodiments include, but are not limited to, a laser beam printer (LBP), a multifunction peripherals (MFP), a multifunction laser beam printer including copy function, an ink jet printer (IJP), a thermal printer (e.g., a dye sublimation printer) and a silver halide printer. For example, the image forming apparatus can be a color printer or a black and white (B/W) printer.

Examples of the networks 120 consistent with embodiments include, but are not limited to, the Internet, an intranet, a local area network (LAN) and a wide area network (WAN). Alternatively, the Internet or network connection 120, which connects the image forming apparatus 101, the one or more client devices 102, 104, 106, 108 can be a wire (or cable) and/or wireless technology including but not limited to radio frequency (RF) and/or infrared (IR) transmission.

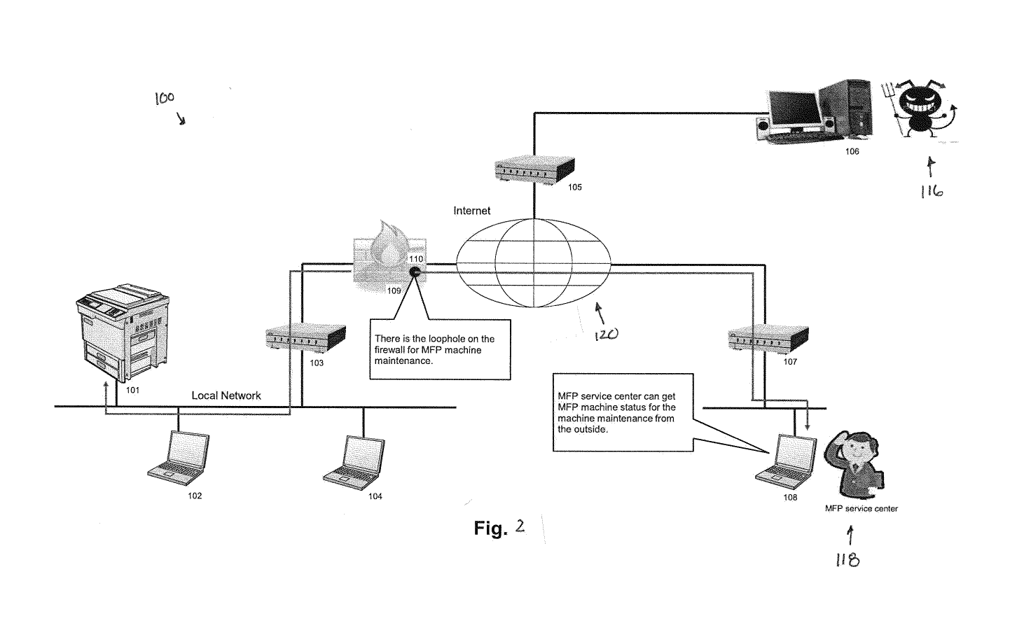

FIG. 2 is an illustration of an image forming system 100, which can be subjected to attacks from outsiders, which are not authorized to access the image forming apparatus 101 in accordance with an exemplary embodiment. As shown in FIG. 2, the system 100 preferably includes a firewall 109. The firewall 109 can be a software or hardware-based network security system or device that controls the incoming and outgoing network traffic. Firewalls 109 typically analyze the data packets received from the client device 102, 104, 106, 108 via the network connection and determine whether the packets should be allowed through or not, based on an applied rule set. For example, a firewall 109 can established a barrier between a trusted, secure internal network and another network (e.g., the Internet 120) that is not assumed to be secure and trusted. In accordance with an exemplary embodiment, the one or more routers, networking devices and/or hubs 103, 105, 107 can pass data between networks containing firewall components and, conversely, many firewalls 109 can perform basic routing functions. However, firewalls 109 can have loopholes 110, which can allow an unauthorized user access, for example, to the image forming apparatus 101.

In accordance with an exemplary embodiment, access to the image forming apparatus 101 can be through the loopholes 110 via the firewall 109. For example, an operator or a service center representative 118 within a service center can access the image forming apparatus 101 from a client device 108, for example, to obtain the status of the image forming apparatus for purposes of scheduling, for example, maintenance on the image forming apparatus 101.

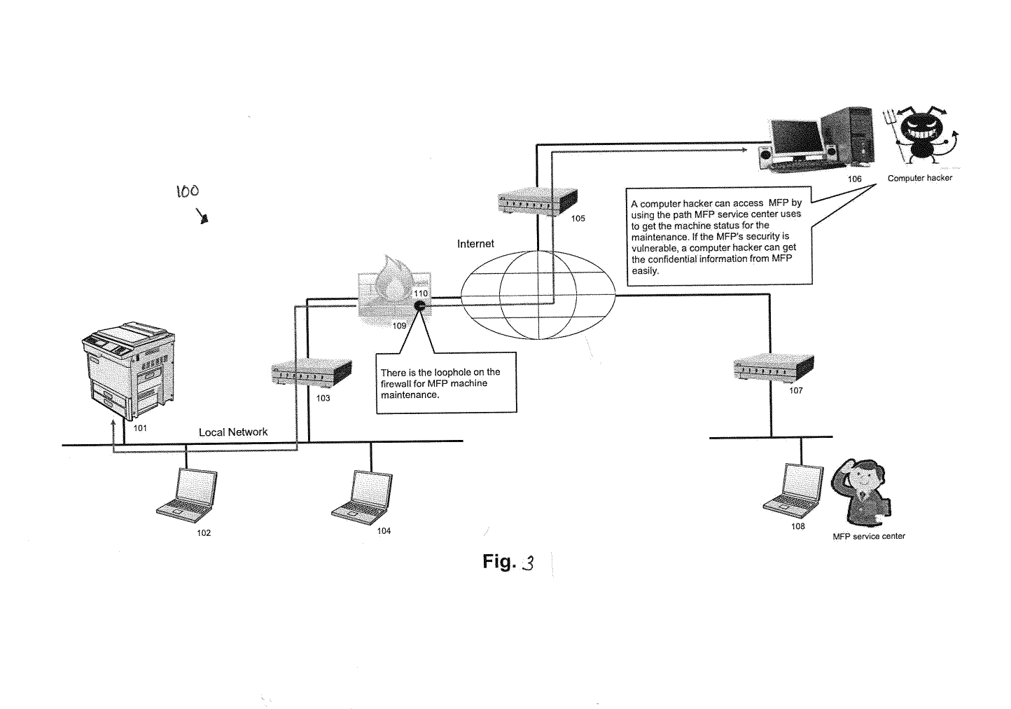

FIG. 3 is an illustration of the image forming system 100, wherein the image forming apparatus 101 can be subjected to an attack from outside the network by a computer hacker 116 using a client device 106 in accordance with an exemplary embodiment. As shown in FIG. 3, the firewall 109 can have a loophole 110, which can be accessed by the computer hacker 116. For example, a computer hacker 116 can access the image forming apparatus 101 using the same path that the service center representative 118 uses to obtain, for example, the status of the image forming apparatus 101. If the image forming apparatus' security is vulnerable, for example, a computer hacker 116 can obtain confidential information from the image forming apparatus 101.

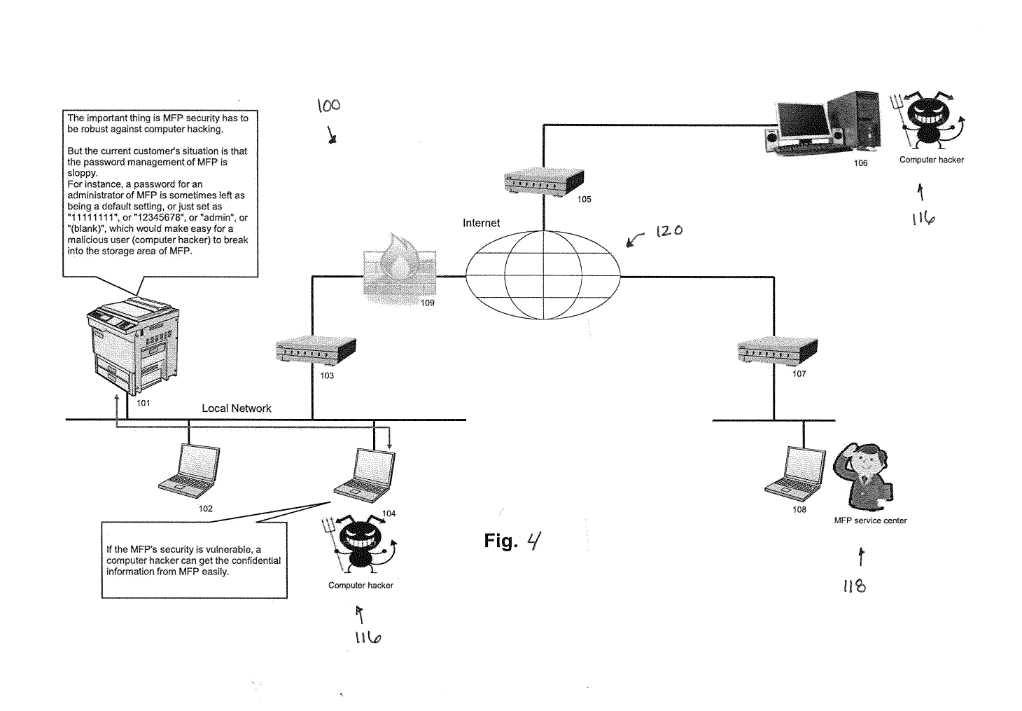

FIG. 4 is an illustration of an image forming system, wherein the image forming apparatus 101 can be subjected to an attack from inside a network by a computer hacker 116 in accordance with an exemplary embodiment. As shown in FIG. 4, in known situations, the password for administrator access of an image forming apparatus 101 after the initialization or set up of the apparatus 101, can often be left as a default setting, or alternatively, a simple set of numbers or letters, such as “11111111”, “12345678”, “admin”, or “common password”, which can be easily discovered by a malicious user (or hacker) 116 to gain access to confidential information stored on the image forming apparatus 101.

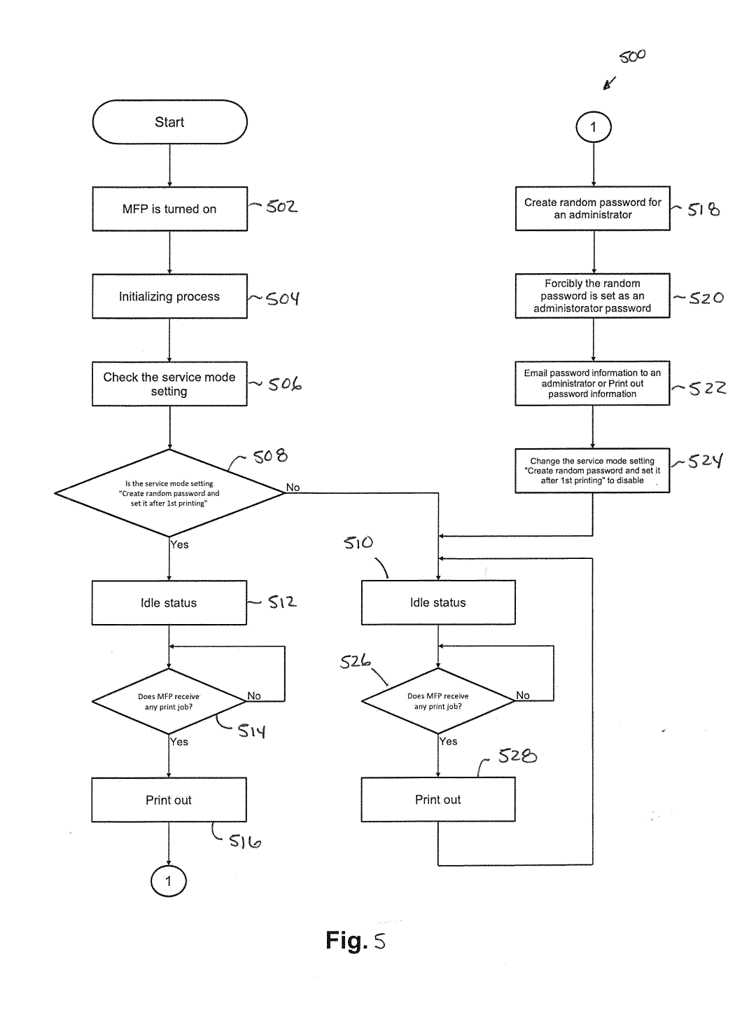

FIG. 5 is a flow chart illustrating a process 500 for generating a password in accordance with an exemplary embodiment. As shown in FIG. 5, the process starts in step 502 when the image forming apparatus 101 is turned “on”, for example, by a service technician preparing the image forming apparatus for image formation. Once the initializing process 504 has been completed and the image forming apparatus 101 is ready for image formation, in step 506, the service technician can access the password setting mode on the image forming apparatus 101 to determine in step 508, if the password setting mode for generating a random password has been set to create a randomly generated password for the image forming apparatus, i.e., “Create random password and set after first printing”. It can be appreciated, that rather than a random generated password, the password can be generated, for example, according to a schedule and/or a listing of preset passwords for the image forming apparatus.

In accordance with an exemplary embodiment, the password setting mode for generating a password or a random password can be enabled in the factory. Thus, in accordance with an exemplary embodiment, the password setting mode is set or “enabled” as a default setting. If the setting for generating a random password after the first printing has not been set, in step 510, the process continues to an idle status. In the idle status 510, the image forming apparatus 101 has been initialized, the image forming apparatus 101 can be ready for image formation, which can include printing a copy job, scanning a document, (i.e., a scan job), sending a facsimile, (i.e., a facsimile (or “fax”) job), or printing a print job.

Alternatively, if the setting for generating a random password after the first setting has been activated, in step 512, the process continues to an idle status. In step 514, a determination is made if the image forming apparatus 101 has received any print jobs. If the image forming apparatus 101 does not receive any print jobs, the image forming apparatus 101 remains in the idle status 512. Once the image forming apparatus 101 is ready for image formation, which, for example, can include receiving a print job from a client device 102, 104, 108, in step 516, the image forming apparatus 101 can generate a printout of the print job in step 516.

In accordance with an exemplary embodiment, confirmation of the status of the image forming apparatus being ready to operate for image formation can be performed by printing a print job, printing a copy job, and/or performing a scan job on the image forming apparatus, or sending a facsimile (fax) from the image forming apparatus, which can automatically generate a password, if the password setting mode is enabled.

In accordance with an exemplary embodiment, the process of generating a printout from a print job or copy job, scanning a document, or sending a facsimile (fax) on the image forming apparatus 101, causes the image forming apparatus 101 in step 518 to automatically generate a password, for example a random password, for a service center representative 118 of the image forming apparatus 101. It can be appreciated that in addition to the service center representative 118, in accordance with an exemplary embodiment, the method and system as disclosed herein can automatically generate a password, for example, a random password for an administrator (not shown) within an intranet, i.e., wherein the administrator can access the image forming apparatus without accessing the internet 120 and the corresponding firewall 109.

The password is preferably a word or string of characters, which can be used for authentication to provide access and/or approval to the image forming apparatus 101. In accordance with an exemplary embodiment, after the printing of the first print job, the random generated password is then set as an administrator password for image forming apparatus 101. In accordance with an exemplary embodiment, the random generated password is forcibly set as the administrator password, which cannot be reset by the administrator other than by the generation of another random generated password. In accordance with an exemplary embodiment, the password is generated without any key input by a service person, the administrator and/or a user of the image forming apparatus.

In step 522, the image forming apparatus 101 can send the random generated password for the image forming apparatus 101 in the form of an e-mail (or electronic mail) to the service center representative 118. Alternatively, in step 522, the random generated password can be printed by the image forming apparatus 101 in the form of a paper print out. In accordance with an exemplary embodiment, the image forming apparatus 101 can notify the administrator of the randomly generated password by, for example, temporarily displaying the password on a graphical user interface of the image forming apparatus 101, displaying the password on screen of a client device 102, 104 or PDA, sending the password as a text message, and/or sending the password in a voice message. In accordance with an exemplary embodiment, the image forming apparatus 101 preferably hosts within the image forming apparatus 101, one or more e-mail addresses for the designated one or more service center representatives 118 for the image forming apparatus 101.

In accordance with an exemplary embodiment, once the randomly generated password has been set, in step 524, the password setting mode to create random password and set after first printing can be disabled or set to “disable”. In accordance with an exemplary embodiment, the disabling of the password setting mode to create a random password can be automatically disabled by the image forming apparatus upon printing of the print job. Thus, for each subsequent print out on the image forming apparatus, a new random generated password will not be generated until the password setting mode to create a random password has been reset or enabled. Once the password setting mode has been enabled, the process for generating a password as disclosed herein can be repeated. For example, in accordance with an exemplary embodiment, the system can be configured to reset the generated password for the image forming apparatus by enabling the password setting mode, re-confirming the status of the image forming apparatus being ready to operate for image formation, which can generate a new password for the image forming apparatus.

In the disabled mode, in step 526, upon receipt of any subsequent print jobs, the image forming apparatus operates in a normal manner. In accordance with an exemplary embodiment, for example, in step 528, the image forming apparatus 101 generates a printout based on the print job without generating a new password.

In accordance with an exemplary embodiment, the generated password for the image forming apparatus can be reset by enabling the password setting mode on the image forming apparatus. Once the password setting mode has been enabled and a subsequent print job is received and/or processes on the image forming apparatus and the subsequent print job on the image forming apparatus is printed, a new password for the image forming apparatus can be generated.

In accordance with an exemplary embodiment, a computer program product comprising a non-transitory computer readable medium having a computer readable code embodied therein for generating a password for an image forming apparatus, the computer readable program code configured to execute a process, which includes the steps of: providing a password setting mode on the image forming apparatus configured to automatically generate a password for the image forming apparatus after the image forming apparatus is ready to operate for image formation; determining if the password setting mode on the image forming apparatus is enabled or disabled; confirming a status of the image forming apparatus being ready to operate for image formation; and if the password setting mode is enabled, automatically generating the password for the image forming apparatus after confirming the status.

The non-transitory computer usable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A method for generating a password for an image forming apparatus, the method comprising:
providing a password setting mode on the image forming apparatus configured to automatically generate a password for the image forming apparatus after initial set up has been performed on the image forming apparatus and wherein the image forming apparatus is ready to operate for image formation;
determining if the password setting mode on the image forming apparatus is enabled or disabled;
confirming a status of the image forming apparatus being ready to operate for image formation; and
automatically generating the password for the image forming apparatus after confirming the status of the image forming apparatus being ready to operate for image formation if the password setting mode is enabled, and wherein the confirming of the status of the image forming apparatus being ready to operate for image forming comprises one of the following:
printing a print job or a copy job on the image forming apparatus;
scanning a document on the image forming apparatus; or
sending a facsimile from the image forming apparatus.

2. (canceled)

3. The method of claim 1, wherein the automatically generated password is a randomly generated password.

4. The method of claim 1, comprising:
forwarding the automatically generated password via e-mail to an administrator and/or a service center representative.

5. The method of claim 1, comprising:
printing the generated password on a physical printout.

6. The method of claim 1, comprising:
resetting the generated password for the image forming apparatus by enabling the password setting mode;
re-confirming the status of the image forming apparatus being ready to operate for image formation; and
generating a new password for the image forming apparatus.

7. The method of claim 1, comprising:
disabling the password setting mode on the image forming apparatus after the image forming apparatus is ready to operate for image formation.

8. A computer program product comprising a non-transitory computer readable medium having a computer readable code embodied therein for generating a password for an image forming apparatus, the computer readable program code configured to execute a process, which includes the steps of:
providing a password setting mode on the image forming apparatus configured to automatically generate a password for the image forming apparatus after initial set up has been performed on the image forming apparatus and wherein the image forming apparatus is ready to operate for image formation;
determining if the password setting mode on the image forming apparatus is enabled or disabled;
confirming a status of the image forming apparatus being ready to operate for image formation; and
automatically generating the password for the image forming apparatus after confirming the status of the image forming apparatus being ready to operate for image formation if the password setting mode is enabled, and wherein the confirming of the status of the image forming apparatus being ready to operate for image forming comprises one of the following:
printing a print job or a copy job on the image forming apparatus;
scanning a document on the image forming apparatus; or
sending a facsimile from the image forming apparatus.

9. (canceled)

10. The computer program product of claim 8, wherein the automatically generated password is a randomly generated password.

11. The computer program product of claim 8, comprising:
forwarding the automatically generated password via e-mail to an administrator and/or a service center representative.

12. The computer program product of claim 8, comprising:
printing the generated password on a physical printout.

13. The computer program product of claim 8, comprising:
resetting the generated password for the image forming apparatus by enabling the password setting mode;
re-confirming the status of the image forming apparatus being ready to operate for image formation; and
generating a new password for the image forming apparatus.

14. The computer program product of claim 8, comprising:
disabling the password setting mode on the image forming apparatus after the image forming apparatus is ready to operate for image formation.

15. An image forming system, the image forming system comprising:
at least one client device; and
an image forming apparatus, the image forming apparatus configured to perform the following:
providing a password setting mode on the image forming apparatus configured to automatically generate a password for the image forming apparatus after initial set up has been performed on the image forming apparatus and wherein the image forming apparatus is ready to operate for image formation;
determining if the password setting mode on the image forming apparatus is enabled or disabled;
confirming a status of the image forming apparatus being ready to operate for image formation; and
automatically generating the password for the image forming apparatus after confirming the status of the image forming apparatus being ready to operate for image formation if the password setting mode is enabled, and wherein the confirming of the status of the image forming apparatus being ready to operate for image forming comprises one of the following:
printing a print job or a copy job on the image forming apparatus;
scanning a document on the image forming apparatus; or
sending a facsimile from the image forming apparatus.

16. (canceled)

17. The image forming system of claim 15, wherein the automatically generated password is a randomly generated password.

18. The image forming system of claim 15, comprising:
forwarding the automatically generated password via e-mail to an administrator and/or a service center representative.

19. The image forming system of claim 15, comprising:
printing the generated password on a physical printout.

20. The image forming system of claim 15, comprising:
resetting the generated password for the image forming apparatus by enabling the password setting mode;
re-confirming the status of the image forming apparatus being ready to operate for image formation; and
generating a new password for the image forming apparatus.

21. The image forming system of claim 15, comprising:
disabling the password setting mode on the image forming apparatus after the image forming apparatus is ready to operate for image formation.
